(19) United States
(12) Patent Application Publication
(10) Pub. No.: US 2015/0305364 A1
(43) Pub. Date: Oct. 29, 2015

(54) PROCESS FOR MAKING CONFECTIONS

(71) Applicant: MARS, INCORPORATED, McLean, VA (US)

(72) Inventor: Wayne PRICE, Slough (GB)

(73) Assignee: MARS, INCORPORATED, McLean, VA (US)

(21) Appl. No.: 14/647,691

(22) PCT Filed: Nov. 14, 2013
(86) PCT No.: PCT/US2013/070054

§ 371 Date: May 27, 2015

Related U.S. Application Data
(60) Provisional application No. 61/736,668, filed on Dec. 13, 2012.

(51) Int. Cl. A23G 1/04; A23G 1/00; A23L 1/025

(52) U.S. Cl. CPC A23G 1/042; A23L 1/025; A23G 1/0036; A23G 1/0033; A23V 2002/00

(57) ABSTRACT

A process for making a confection is disclosed including exposing the confection, or a precursor thereof, to electromagnetic radiation. The process is capable of manipulating the rheological characteristics of the confection or confection precursor without altering the temperature of the confection, or changing the composition thereof. The changes in rheological characteristics are advantageously temporary and reversible. Finally, the process requires minimal capital expenditure, may readily be incorporated into an existing process an onto existing equipment, and requires minimal energy consumption.

### FIELD

The present invention relates to processes for making, or treating, confections.

### BACKGROUND

The manufacture of confections can be a complicated and expensive process at least because many of the components utilized are sensitive to the processing conditions required to manipulate them into their desired format. For example, in certain processing steps, confections and/or components thereof may desirably be fluid, while in others, gelation or even solidification can be desired. Indeed, viscosity and/or rheology manipulation is critical at many steps of the manufacturing process.

Conventional methods of controlling or manipulating viscosity include application or removal of heat, altering the composition of the confection or mechanically altering the rheology of the composition through pumping or stirring. Each of these can be suboptimal in certain applications.

For example, application of excessive heat can result in the confection exhibiting unsatisfactory sensory attributes, such as diminished texture, mouth feel, appearance or flavor. Altering the composition of the confection may also assist in maintaining a desired, and processable, viscosity, but doing so may also undesirably alter the flavor profile of the confection. Mechanically adjusting the rheology or viscosity of the confection or components thereof can require capital expenditure for suitable equipment to do so, as well as the manufacturing space and utility cost of operating the same, not to mention the time such steps can require.

It would thus be of benefit to those operating in the art of confectionary manufacture to have a means to alter the viscosity, rheology or flow properties of a confection, or components thereof, without the need to adjust the temperature or the composition of the confection. Further advantage would be provided if any such method could be implemented with minimal disruption to a conventional process for the manufacture of the confection, i.e., with minimal additional time, cost, and/or space requirements.

### BRIEF DESCRIPTION

The present invention provides a method of externally controlling or altering the rheology or viscosity of fluid confections without the application of heat and without changing the composition thereof. Through application of this technology, the baking and confection industry can externally control the flow properties of fluid confections such as chocolate, caramel, and sugar solutions and suspensions without worry of introducing deleterious sensory attributes into the confection. Controlling the heat transfer properties of fluid foods with an electric field can have a significant impact on a food process design.

In one aspect, a process for making a confection is provided. The process comprises exposing the confection, or a precursor thereof, to electromagnetic radiation. The confection may be a fluid, such as a liquid, or may be a solid. Examples of confections that could benefit from application of the present method include, but are not limited to, chocolate, caramel, cocoa liquor, sugar solutions, sugar suspensions or combinations thereof. The electromagnetic radiation can be used to alter the rheological characteristics of the confection or confection precursor, and in some embodiments, can be used to manipulate the viscosity of the confection, i.e., by increasing or decreasing it.

The electromagnetic radiation may be supplied in any suitable format, such as via electric field, a magnetic field, an electromagnetic field, or a combination of these. Electromagnetic fields, for example, can be generated by creating a potential across a conduit, or other conveyance, comprising the confection by any suitable means, including via a capacitor. In some embodiments, benefits may be realized by applying the electromagnetic radiation at a strength of from about 1 V/mm to about 2000 V/mm. The electromagnetic radiation may be pulsed, i.e., applied for a first time period and then discontinued for a second time period. In such embodiments, the first and second time periods may be the same or different and the pulses repeated any number of times.

In some embodiments, the radiation exposure may cause the particles within the confection to form aggregates of particles within the electric field, in a size and number such that viscosity of the confection, or confection precursor, is altered, e.g., reduced.

In another aspect, an apparatus for processing a confection is provided. The apparatus comprises a conduit or conveyance for transporting, or a vessel for housing, the confection. At least two, and in some embodiments, a plurality of, devices for producing electromagnetic radiation are provided and are operably disposed relative to the conduit, conveyance or vessel. The devices comprise electrodes, leads, webbing, electromagnets, or a combination of these. The field strength applied by each device may be the same, or different. The apparatus further comprises at least one apparatus unique to confectionary processing, such as a roll refiner or conching device.

### DETAILED DESCRIPTION

The present specification provides certain definitions and methods to better define the present invention and to guide those of ordinary skill in the art in the practice of the present invention. Provision, or lack of the provision, of a definition for a particular term or phrase is not meant to imply any particular importance, or lack thereof. Rather, and unless otherwise noted, terms are to be understood according to conventional usage by those of ordinary skill in the relevant art.

The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation.

If ranges are disclosed, the endpoints of all ranges directed to the same component or property are inclusive and independently combinable (e.g., ranges of “up to 25 wt. %, or, more specifically, 5 wt. % to 20 wt. %,” is inclusive of the endpoints and all intermediate values of the ranges of “5 wt. % to 25 wt. %,” etc.). As used herein, percent (%) conversion is meant to indicate change in molar or mass flow of reactant in a reactor in ratio to the incoming flow, while percent (%) selectivity means the change in molar flow rate of product in a reactor in ratio to the change of molar flow rate of a reactant.

Reference throughout the specification to “one embodiment” or “an embodiment” means that a particular feature, structure, or characteristic described in connection with an embodiment is included in at least one embodiment. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The present invention contemplates the possibility of omitting any components or steps listed herein. The present invention further contemplates the omission of any components or steps even though they are not expressly named as included or excluded from the invention.

The term “about,” as used herein, refers to variations in the numerical quantity that can occur, for example, through typical measuring and liquid handling procedures used for making compositions; through inadvertent error in these procedures; through differences in the manufacture, source, or purity of the ingredients employed to make the compositions or carry out the methods; and the like. The term “about” also encompasses the degree of error associated with measurement of the particular quantity.

The present invention provides a process for making a confection comprising exposing the confection, or confection precursor, to an electromagnetic field. This exposure may be used to alter the rheological properties of the confection or precursor, e.g., the exposure may be used to alter the viscosity of the confection or precursor. While not wishing to be bound by any theory, it is believed that when an electric, or electromagnetic, field is applied to such confections or precursors in a fluid state, polar particles within the confection or precursor thereof link together to form chains. These chains are then believed to orient themselves to be parallel with the applied field. This orientation, in turn, is believed to increase the directional thermal conductivity of such fluids, providing a direct path for energy transfer through the material.

While electrorheology has been tested with respect to altering the rheology of petroleum and crude oil, these materials are extremely different compositions than confections. For one, confections are blends of many complex components, any one of them capable of shielding the others from the effects of electromagnetic radiation. And, while petroleum or crude oil does not separate when subjected to increased temperatures, confections are extremely sensitive to the same, and may separate, seize, or acquire a burned flavor at high temperatures. Furthermore, it has been reported that applying electric fields to petroleum results in gelling or thickening of the petroleum. In contrast, applying electromagnetic fields to crude oil has resulted in thinning of the crude oil. And so, even in these electrorheological fluids, the effect of electromagnetic radiation is not guaranteed, and those of ordinary skill would not consider applying it to a confection out of concern that the effect, if any, would be undesirable, or even detrimental.

It has now been surprisingly discovered that the application of electromagnetic radiation can successfully be used in the processing of confections, to alter the rheological properties thereof. Furthermore, such application does not result in the overheating or seizing of the chocolate, nor does it impart an off flavor to the resulting confection. Indeed, the effects of exposure to electromagnetic radiation can be temporary and reversible. And, electromagnetic radiation may easily and inexpensively be incorporated into confectionary manufacturing processes, inasmuch as equipment for generating such fields is readily commercially available and typically, capable of being manipulated to surround, or otherwise be operably disposed relative to the confection.

The confection, or precursor, may be in any format, whether it be solid, gelled, fluid when contacted with the electromagnetic radiation. For example, solid confections or precursors thereof may be contacted with electromagnetic radiation for a period of time sufficient to alter the rheology of any liquid components thereof. In those embodiments, wherein the confection or precursor comprises a fluid, the electromagnetic radiation may advantageously be used to manipulate, i.e., to reduce or increase, the viscosity of the fluid.

While the process is applicable to any confection or precursor, in any format, particular advantage can be seen when the process is applied to fluids which are too viscous, due at least in part to temperature considerations or compositional considerations, to be easily transported or piped from one location to another during processing. In such embodiments, application of an electromagnetic field to the confection can be used to reduce the viscosity of the confection so that flow of the confection through the process is facilitated and/or to reduce, or eliminate, the precipitation of solids which might cause blockage or reduced flow through conduits through which the confection must pass. A fluid confection having a lower viscosity is easier to transport from one mixing apparatus to another or to deposit into molds.

As one skilled in the art will recognize, the strength of the electromagnetic field to be applied and duration of application will depend on the composition of the confection or precursor, the desired degree of viscosity alteration desired, the temperature of the confection fluid, and the period during which the field is to be applied. If the field strength is too low or the application period too short, an insignificant change in viscosity may result. Conversely, if the strength of the electric field is too high or the period of application too long, the viscosity of the fluid may increase, or increase to an undesired level, which may be desirable in some embodiments, but unexpected or undesired in others. In some embodiments, it may be the case that the higher the initial viscosity of the fluid before being subjected to the electric field, the greater the reduction in viscosity after being subjected to the electric field. On the other hand, a lower initial viscosity of the confection fluid before being subjected to the electric field, may result in a greater increase in viscosity after being subjected to the electric field.

Generally speaking, in order to obtain a desired reduction in viscosity, applied electromagnetic fields having a strength of at least about 1 V/mm, at least about 5 V/mm, or at least about 10 V/mm are believed to be suitable. For example, the field strength may suitably be in the range of about 1 V/mm up to about 2000 V/mm, for example in the range of about 100 V/mm to about 1500 V/mm, for example in the range of about 250 V/mm to about 1000 V/mm, for example in the range of about 500 V/mm to about 800 V/mm. In order to reduce viscosity it is expected that the exposure period is suitably in the range of from about 1 second to about 300 seconds, for example, from about 1 second to about 100 seconds.

In other embodiments, the process may be utilized to increase the viscosity of a fluid confection once transportation or processing is complete. In such embodiments, applied electromagnetic fields having a strength of at least about 2000 V/mm, at least about 2500 V/mm, at least about 3000 V/mm, at least about 3500 V/mm, or at least about 4000 V/mm are believed to be suitable. For example, the field strength may suitably be in the range of about 2000 V/mm up to about 5000 V/mm, for example in the range of about 2500 V/mm to about 4500 V/mm, for example in the range of about 3000 V/mm to about 4000 V/mm. In order to increase viscosity it is expected that the exposure period of fields of such strength are suitably in the range of from about 1 second to about 300 seconds, for example, from about 1 second to about 100 seconds.

Or lower strength fields can be applied, but for longer periods of time, and increases in viscosity seen. In such embodiments, for example, the field strength may suitably be in the range of about 1 V/mm up to about 2000 V/mm, for example in the range of about 100 V/mm to about 1500 V/mm, for example in the range of about 250 V/mm to about 1000 V/mm, for example in the range of about 500 V/mm to about 800 V/mm. In order to reduce viscosity it is expected that the exposure period is suitably in the range of from about 100 seconds to about 300 seconds, for example, from about 100 second to about 200 seconds.

By applying the electromagnetic field within these ranges of strength and period, it is hypothesized that nearby polar particles such as milk proteins and/or sugar, tend to aggregate into larger particles. As the average particle size increases, the viscosity is reduced. And so, in embodiments wherein viscosity reduction is desired, it may be desirable to limit the applied field strength and time to that which results in the formed aggregates being, e.g., on the order of micrometers in size. On the other hand, if increased viscosity is desired, it may be appropriate to apply a stronger field strength or the same field strength for a longer period of time, so that macroscopic aggregates are formed.

A direct current (DC) or an alternating current (AC) may be used to generate the electric/electromagnetic field. When applying an electric field, the frequency of the applied field is in the range of about 1 to about 3000 Hz, for example from about 25 Hz to about 1500 Hz. This field can be applied in a direction parallel to the direction of the flow of the confection fluid or it can be applied in a direction other than the direction of the flow of the confection fluid.

The electromagnetic radiation can be supplied by any suitable means, and many of these are known to those of ordinary skill in the art. In some embodiments, the electromagnetic radiation is supplied using a capacitor. The capacitor may be of any type suitable to apply such an electric field to a confection comprising a fluid. Suitable examples include at least two metallic meshes surrounding, or within, a conduit. Alternatively, a lead may be placed on either side of a conduit so that electric/electromagnetic field is created across the leads while a voltage potential is maintained. The confection, or precursor, is then caused to pass through the conduit, experiencing a short pulse electric field as a constant voltage is applied to the capacitor.

Other types of capacitors may also be used to practice the present invention. In one exemplary embodiment, the field is applied in a direction parallel to the direction of the flow of the confection, precursor or fluid portion thereof. This type of capacitor can be used to generate pulse electric fields that can be applied to the fluid confection. In yet another embodiment, the electric field may be generated by a capacitor across which the electric field is applied in a direction other than the direction of the flow of the confection fluid. It is contemplated that the field can be applied in almost any feasible direction across the confection or precursor and still provide the desired result.

Once the electromagnetic radiation is removed, or the exposure thereto otherwise ceased, the viscosity of the confection or precursor thereof may return toward its original value. In order to maintain a desired viscosity range, the confection may be re-exposed to the electromagnetic radiation periodically. In some embodiments, such re-exposure can be readily implemented by passing the confection through a conduit, or passing it via some other conveyance, having sources of the electromagnetic radiation operably disposed at appropriate intervals along the conduit or conveyance. For example, it may be desirable to reapply the electric field at intervals ranging, for example, from about 1 minute to about 20 minutes as the confection fluid progresses along its path of travel to ensure that desired effect of the electromagnetic radiation is substantially maintained.

Once the electric field is removed, the rate at which the viscosity may return to its original value may similarly decrease over time. As previously described, and while not wishing to be bound by any theory, it is believed that applying electric or magnetic fields to the confection or precursor results in aggregation of particles in the confection or precursor. It is further believed that once the source of electromagnetic radiation is removed, the aggregated particles formed during application of the radiation gradually disassemble. The return of the confection or precursor to its original viscosity may depend upon Brownian motion time-scales. Typically, and depending on the size and number of the aggregates, the fluid confection may retain its altered viscosity for several minutes or up to several hours, returning to its initial value after 30 minutes, one hour, two hours, three hours, four hours, or after 5 hours or more.

The viscosity altering affect that is experienced by the confection or precursor may be adjusted or enhanced by applying one or more mechanical manipulations to the confection before, during, or after exposure to the electromagnetic field. Such mechanical manipulation includes, but is not limited to, agitating the confection as by vibrating, stirring, pumping or conching continuously, or in pulses. However, a particular advantage of the present process is that mechanical intervention, thermal intervention, and compositional intervention are not required to manipulate the rheological properties of the confection, and although such mechanical manipulations can be performed within the process as conventional, they are not necessary to the operability of the process. Rather, any additional mechanical manipulations performed to enhance the impact of exposure to the electromagnetic field are purely optional.

In some embodiments, the frequency and/or amplitude of the electric and/or magnetic waves may be adjusted during each exposure, or to be different during different exposure periods, to optimize results. Any such adjustment will contemplate the physical properties of the confection. For example, a certain fluid confection may require applying high amplitude and low frequency waves while another may require applying high frequency and low amplitude waves.

The temperature and/or viscosity of the confection when exposed to the electromagnetic radiation can impact the magnitude of the impact of the radiation on the confection. That is, the impact of the radiation may have a greater or lesser impact depending upon the pre-exposure temperature and/or viscosity of the confection. One skilled in the art can appreciate that at lower temperatures/higher viscosities, a greater change in the temperature/viscosity is possible than at higher temperatures/lower viscosities, in particular if a decrease in viscosity is desired. The opposite may be true if an increase in viscosity is desired, i.e., exposing the confection to electromagnetic radiation when at higher temperatures and lower viscosities is likely to produce a smaller change than if an increase in viscosity is desired in a confection with a lower temperature and/or higher viscosity.

An apparatus for the exposure of a confection or precursor thereof to electromagnetic radiation is also contemplated. The apparatus comprises a plurality of devices for producing at least one of electric, magnetic, and/or electromagnetic field spaced along a conduit, or other conveyance, for transporting a confection. Or, the devices may be operably disposed relative to a vessel containing the confection. Another apparatus unique to confectionary processing is provided, and may be, e.g., a roll refiner and/or a conching device.

In another embodiment, a plurality of devices may be arranged about the confection, or the vessel or conduit containing the confection, in a two-dimensional array of alternating electrodes at different electric potentials. Suitable devices include electrodes, leads, webbing, electromagnets, etc., or combinations of any number of these. The field strength applied by each device can be the same or different, as can the length of time the field is applied, and are determined relative to one another, as well as in light of the current properties, e.g., temperature and viscosity, of the confection to be exposed.

In operation of the apparatus, as the confection is transported through a conduit, or along a conveyance having at least two, e.g., leads or electrodes operatively disposed relative thereto, the at least two leads apply a field through the confection, thereby exposing it to electromagnetic radiation. The field is generated by applying an electric potential difference between the at least two leads or electrodes. The electric potential difference applied may be pulsed, i.e., may be applied for a first time period and discontinued for a second time period, and this sequence repeated one or more times. The electric field may be modulated upwardly or downwardly as required or desired for a particular confection, as may either or both of the time periods. The time periods may be of the same length, or different.

Advantages of employing the present invention to manipulate the rheological characteristics of a confection are numerous. First, any change in one or more characteristics of the confection is temporary and reversible. Second, the process does not require increasing or reducing the temperature of the confection. Third, the process does not require the composition of the confection to be changed, e.g., as by addition of thickening or thinning agents. Finally, the process requires minimal capital expenditure, may readily be incorporated into an existing process or onto existing equipment, and requires minimal energy consumption.

### EXAMPLE 1

A DC electric field of 600 V/mm is applied to a molten chocolate for 60 seconds. The molten chocolate is obtained by melting commercially available chocolate bars over a double boiler. The molten chocolate has an initial viscosity at ambient temperature (70° F., 21° C.). After exposure to the electric field, the viscosity of the molten chocolate will decrease to about 20% of its initial value. Within 30 minutes after the electric field is removed, the viscosity of the molten chocolate will be within about 5% of the original viscosity. The rate of viscosity increase after the first 30-minute application period is expected to drop considerably.

### EXAMPLE 2

A DC electric field of 600 V/mm is applied to a fluid caramel for 60 seconds. The fluid caramel is obtained by melting commercially purchased caramels over a double boiler. The fluid caramel has an initial viscosity at ambient temperature (70° F., 21° C.). After exposure to the electric field, the viscosity of the fluid caramel will decrease to about 20% of its initial value. Within about 30 minutes after removal of the electric field, the viscosity of the caramel will be within about 5% of the original viscosity. The rate of viscosity increase after the first 30-minute application period is expected to drop considerably.

### EXAMPLE 3

An 50-Hz AC electric field of 600 V/mm is applied to each of a fluid caramel and a molten chocolate for 30 seconds each. As in Examples 1 and 2 above, the fluid caramel and molten chocolate are obtained by melting commercially purchased chocolate bars and caramels over double boilers. Each of the fluid confections would have an initial viscosity at ambient temperature (70° F., 21° C.). After exposure to the electric field, the viscosity of each of the molten chocolate and the fluid caramel will decrease to about 20% of its initial value. Within about 30 minutes of removal of the electric field, the viscosity of each of the caramel and chocolate will be within about 5% of their original viscosity. The rate of viscosity increase after the first 30-minute period is expected to drop considerably.

The results as shown in Examples 1, 2 and 3 would indicate that both DC electric fields and low-frequency AC fields are effective in reducing the apparent viscosity of the fluid confection samples tested.

### EXAMPLE 4

A DC electric field of 3000 V/mm is applied to a molten chocolate for 60 seconds. The molten chocolate is obtained by melting commercially available chocolate bars over a double boiler as provided above in Example 1. The molten chocolate would have an initial viscosity at ambient temperature (70° F., 21° C.). After exposure to the electric field, the viscosity of the molten chocolate will increase about 70% over its initial value. Within 30 minutes of removal of the electric field, the viscosity will be within about 25% of the chocolate's original viscosity. The rate of viscosity increase after the first 30-minute period is expected to drop considerably.

This result shows that the effect of the electric field may reverse as the intensity gets higher.

1. A process for making a confection comprising exposing the confection, or a precursor thereof, to electromagnetic radiation.

2. (canceled)

3. The process of claim 1, wherein the confection, or confection precursor, comprises chocolate, caramel, cocoa liquor, sugar solution, sugar suspension or combinations thereof.

4. (canceled)

5. (canceled)

6. (canceled)

7. (canceled)

8. (canceled)

9. The process of claim 1, wherein the confection or confection precursor is exposed to the electromagnetic radiation by creating a voltage potential across a conduit comprising the confection or confection precursor.

10. (canceled)

11. The process of claim 1, wherein the electromagnetic radiation has a strength of from about 1 V/mm to about 2000 V/mm.

12. The process of claim 11, wherein the exposure causes the viscosity of the confection or confection precursor to decrease.

13. The process of claim 1, wherein the electromagnetic radiation has a strength of from about 2000 V/mm to about 5000 V/mm.

14. The process of claim 13, wherein the exposure causes the viscosity of the confection or confection precursor to increase.

15. The process of claim 1, wherein confection is exposed to the electromagnetic radiation for a time period of from about 1 second to about 100 seconds.

16. The process of claim 1, wherein the electromagnetic radiation is applied for a first time period and discontinued for a second time period.

17. The process of claim 16, wherein the application and discontinuance of the electromagnetic radiation is repeated.

18. The process of claim 16, wherein first and second time period are the same.

19. The process of claim 16, wherein the first and second time periods are different.

20. The process of claim 1, wherein the confection or confection precursor is a fluid and exposure to the electromagnetic radiation causes the particles within the confection or confection precursor to form aggregates of particles within the electric field.

21. The process of claim 20, wherein size and number of the aggregates is sufficient to reduce the viscosity of the confection or confection precursor.

22. An apparatus for processing a confection or confection precursor, comprising:
A conduit or conveyance for transporting, or a vessel for housing, the confection or confection precursor,
At least two devices for producing electromagnetic radiation operably disposed relative to the conduit, conveyance or vessel; and
At least one apparatus unique to confectionary processing.

23. (canceled)

24. The apparatus of claim 22, wherein the devices comprise electrodes, leads, webbing, electromagnets, or a combination of these.

25. The apparatus of claim 22, wherein the field strength applied by each device is the same.

26. The apparatus of claim 25, wherein the field strength applied by each device is different.

27. The apparatus of claim 22, wherein the apparatus unique to confectionary processing comprises a roll refiner or conching device.
